(19) United States
(12) Patent Application Publication
(10) Pub. No.: US 2011/0087143 A1
(43) Pub. Date: Apr. 14, 2011

(54) THREE-DIMENSIONAL LAYER FOR A GARMENT OF A HFCWO SYSTEM

(76) Inventors: John A. Bobey, Daniel Island, SC (US); Edward Harber, Portland, OR (US); Stephen J. Wiater, Southwick, MA (US)

(21) Appl. No.: 12/903,290

(22) Filed: Oct. 13, 2010

Related U.S. Application Data
(60) Provisional application No. 61/251,518, filed on Oct. 14, 2009.

(51) Int. Cl. A61H 7/00

(52) U.S. Cl. 601/152

(57) ABSTRACT

A garment, such as a vest, for applying HFCWO treatment to a patient includes an outer garment and an air bladder coupled to the outer garment. The outer garment includes an outer shell and an inner liner coupled to the outer shell to define a pocket between the outer shell and the inner liner. The air bladder is removably received within the pocket and the inner liner is made from a 3D material.

### CROSS-REFERENCE TO RELATED APPLICATIONS

The present application claims the benefit, under 35 U.S.C. §119(e), of U.S. Provisional Application No. 61/251,518 which was filed Oct. 14, 2009 and which is hereby incorporated by reference herein.

### BACKGROUND

The present disclosure relates to chest compression devices and in particular to a high-frequency chest wall oscillation (HFCWO) device.

Manual percussion techniques of chest physiotherapy have been used for treatment of a variety of diseases in order to remove the excess mucus that collects in the lungs. A non-exhaustive list of such diseases includes cystic fibrosis, emphysema, asthma and chronic bronchitis to remove the excess mucus that collects in the lungs. Subjecting the patient's chest and lungs to pressure pulses or vibrations decreases the viscosity of lung and air passage mucus, thereby enhancing fluid mobility and removal from the lungs to open airways and mobilize secretions.

To alleviate dependency on a care giver to provide this therapy, chest compression devices have been developed to produce high frequency chest wall oscillation (HFCWO). These devices use an air pulse generator, a vest having air bladders that surround the chest of the patient, and one or more hoses pneumatically coupling the air pulse generator with the vest. The air pulse generator is a mechanical device which operates to supply air under pressure to the bladders in regular patterns of pulses. Illustratively, the vests may be reusable or single patient use items.

One illustrative devices used to produce HFCWO is The Vest® airway clearance system by Hill-Rom Services, Inc. (Batesville, Ind.). Additional pneumatic chest compression devices have been described in U.S. Pat. Nos. 4,838,263; 5,543,081; 6,036,662; 6,254,556; 6,547,749; and 7,725,203, the disclosures of each of which are hereby expressly incorporated by reference herein.

### SUMMARY

The present invention comprises a HFCWO vest, or a component thereof, that has any one or more of the features listed in the appended claims and/or any one or more of the following features, which alone or in any combination may comprise patentable subject matter:

According to one aspect of the present disclosure, a garment for applying HFCWO treatment to a patient includes an outer shell, an inner liner coupled to the outer shell to define a pocket between the outer shell and the inner liner, and an air bladder removably received within the pocket. The inner liner is made from a three dimensional (3D) material.

In one illustrative embodiment, the 3D material may include an outer layer, an inner layer, and a third layer woven between the outer and inner layers. Both the outer and inner layers may be made from a woven fabric. Further, the outer layer may include first apertures formed therethrough and the inner layer may include second apertures formed therethrough. The first apertures may be larger than the second apertures. Illustratively, the inner layer including the second apertures may be configured to lie adjacent a patient during HFCWO treatment and the outer layer including the second aperture may be adjacent an inner surface of the outer shell.

In another illustrative embodiment, an outer edge of the inner liner and an outer edge of the outer shell may be aligned with and coupled to each other. Illustratively, the garment may further includes a zippered connection between a bottom edge of each of the outer shell and the inner liner.

In still another illustrative embodiment, the inner liner may be configured to be compressed and expanded during HFCWO treatment as the bladder is pulsed.

In yet another illustrative embodiment, the bladder may include two plastic sheet members welded to each other only at the outer edge of the sheet members such that the bladder is void of any welds which extend away from the outer edge of the sheet members toward a center of the sheet members. Illustratively, one of the plastic sheet members may be perforated to allow air to pass therethrough. Further illustratively, the plastic sheet member adjacent the inner liner may be perforated. Alternatively, or in addition to the perforations, the outer edges of the plastic sheet members may be welded intermittently to provide leak areas to allow air to pass therethrough.

In still another illustrative embodiment, the bladder may include first snap fastener connectors and the outer shell may include second snap fastener connectors configured to mate with the first snap fastener connectors in order to removably couple the bladder to the outer shell.

Illustratively, a portion of at least one of the bladder, the inner liner, and the outer shell may be antimicrobial.

In yet another illustrative embodiment, the inner liner may include an inner mesh layer and an outer mesh layer. Illustratively, the inner liner may further include a middle region between the inner and outer mesh layers. The middle region may include a plurality of fibers coupled to and woven between each of the inner and outer layers as well as air spaces between the fibers. Illustratively, fibers of the middle region may be substantially vertically oriented between the inner and outer layers. Further illustratively, the inner layer may include first apertures and the outer layer may include second apertures larger than the first apertures. The inner layer may be configured to lie adjacent the patient and the outer layer may be configured to engage the bladder. Illustratively, the first apertures may be diamond-shaped and the second apertures may be circular in shape.

According to another aspect of the present disclosure, a method of providing HFCWO treatment includes securing a garment around the chest of a patient, wherein the garment includes an outer shell, an inner liner coupled to the outer shell, and a bladder removably received within a space between the outer shell and the inner liner. The method further includes coupling the bladder to an air pulse generator, pulsing the bladder between 5-20 Hz, circulating air between the bladder and the patient to cool the patient and remove moisture vapor.

Illustratively, the inner liner may include inner and outer layers and support fibers woven between the inner and outer layers. Further illustratively, circulating air between the bladder and the patient may include collapsing and expanding the inner and outer layers at approximately the same rate at which the bladder is pulsed.

Additional features, which alone or in combination with any other feature(s), such as those listed above, may comprise patentable subject matter and will become apparent to those skilled in the art upon consideration of the following detailed description of various embodiments exemplifying the best mode of carrying out the embodiments as presently perceived.

### BRIEF DESCRIPTION OF THE DRAWINGS

The detailed description particularly refers to the accompanying figures, in which:

FIG. 1 is a perspective view of a patient undergoing HFCWO treatment using a vest of the present disclosure;

FIG. 2 is a rear view of a portion of the vest showing an outer shell of the vest and an inner bladder of the vest;

FIG. 3 is a rear view of a portion of the vest again showing the outer shell and the inner bladder in phantom attached to the outer shell;

FIG. 4 is a perspective view of the vest in a closed configuration;

FIG. 5 is diagrammatic sectional view of a portion of the vest adjacent a patient showing the layers of the vest;

FIG. 6 is a perspective view of a portion of an inner liner of the vest;

FIG. 7 is a perspective view of an outer mesh layer of the liner;

FIG. 8 is a perspective view of an inner mesh layer of the liner;

FIG. 9 is a sectional view of the inner liner of the vest; and

FIG. 10 is a sectional view of another illustrative inner liner of the vest.

### DETAILED DESCRIPTION

A high frequency chest wall oscillation (HFCWO) system 10 includes a vest 12 which fits around the chest of a patient 14, an air pulse generator 16, and two illustrative air hoses 18 coupled to and configured to extend between the vest 12 and the air pulse generator 16 in order to communicate the air pulses from the generator 16 to the vest 12 to provide HFCWO therapy to the patient 14. During treatment, the air pulse generator 16 generates oscillatory pulses which travel to the vest 12 through the hoses 18 in order to deliver oscillatory chest compressions to the chest of the patient 14 to open airways, mobilize secretions, and clear mucus from the lungs of the patient 14. As is discussed in greater detail below, an inner liner 22 of the vest operates to circulate and cool air between the patient 14 and the vest 12.

Illustratively, the air pulse generator 16 includes, among other things, an outer shell or housing 29, and a controller and an air pulse module contained within the housing 29 in order to produce the oscillatory pulses needed to treat the patient 14. Illustrative air pulse generators are described within U.S. Pat. Nos. 7,121,808; 7,316,658; 7,582,065; 7,425,203; and 7,115,104, the disclosures of each of which are hereby incorporated by reference herein. It is within the scope of this disclosure, however, for the HFCWO system 10 to include other air pulse generators as well. Further, while the system 10 is shown to include two hoses 18, it is within the scope of this disclosure to provide a HFCWO system having any suitable number of hoses between the air pulse generator 16 and the vest 12.

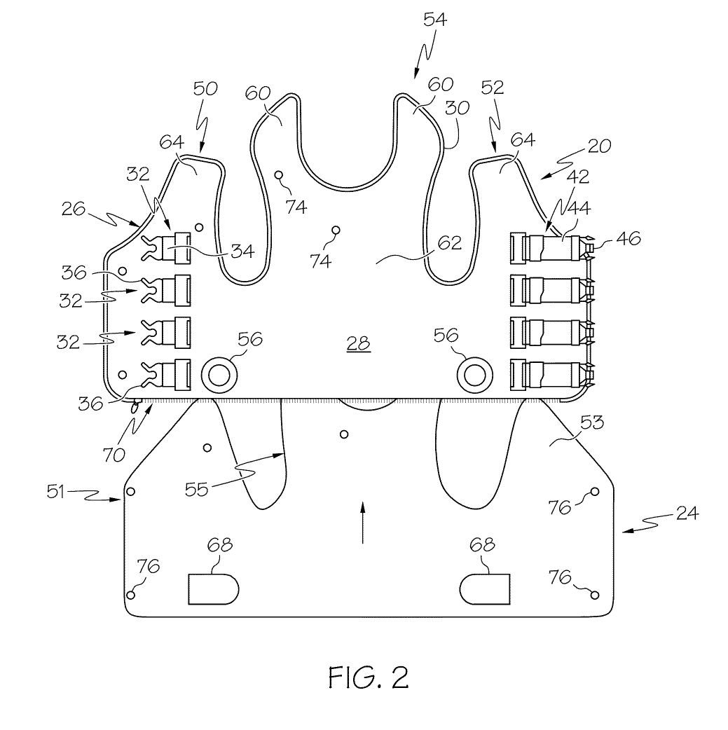

Looking now to FIGS. 2-5, the vest 12 includes an outer portion 20 and an air bladder 24 coupled to the outer portion 20. As is discussed in greater detail below, the outer vest portion 20 includes an outer shell 26 and an inner liner 22 (shown in FIGS. 5-10) coupled to the outer shell 26 to create a pocket 27 therebetween. The bladder 24 is configured to be positioned within this pocket 27 between the outer shell 26 and the liner 22. Further, the inner liner 22 is made from a three-dimensional (3D) woven material which operates to move moisture vapor and heat away from the patient 14 during HFCWO treatment.

The outer shell 26 includes an outer surface 28 configured to face away from the patient 14 when the vest 12 is worn by the patient 14 and an inner surface 30 configured to face toward the patient 14 when the vest 12 is worn by the patient 14. Illustratively, the outer shell 26 is made from a generally non-stretch nylon material. It is within the scope of this disclosure, however, for the outer shell 26 to include portions made from a stretch material, such as a Lycra® fabric material and or a stretch Lycra® binding, for example. Of course, other suitable stretchable and non-stretchable materials may be used as well.

Illustratively, the outer shell 26 may also be made of a water resistant and/or stain resistant material. Further, the outer shell 26 may be made of a washable material to allow the patient 14 or other caregiver to remove the inner bladder 24 and liner 22 from the outer shell 26 such that the shell 26 may be washed in a washing machine or otherwise disinfected. Illustratively, the inner liner 22 may be washed in a washing machine or otherwise disinfected as well. The outer shell 26 may also be made of a light weight material in order to reduce the overall weight of the vest 12 and accommodate the comfort of the patient 14. Illustratively, the outer shell 26 may also include one or more pockets (not shown) to allow a patient 14 to carry or store items such as MP3 player, medications, etc., therein.

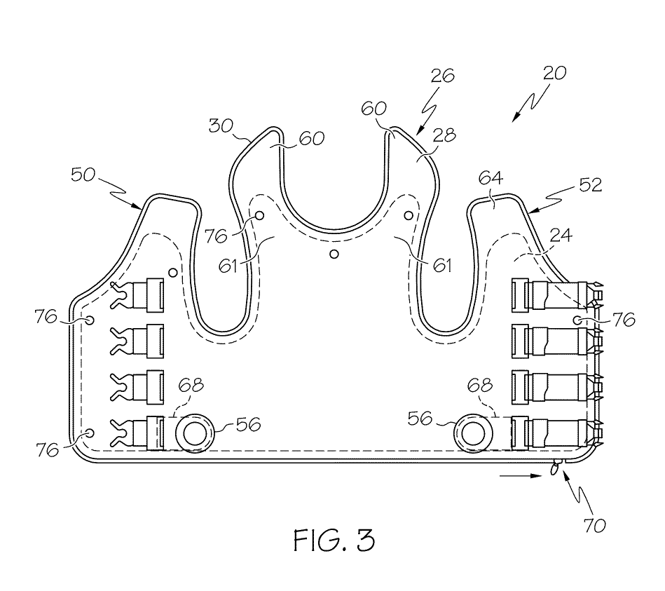

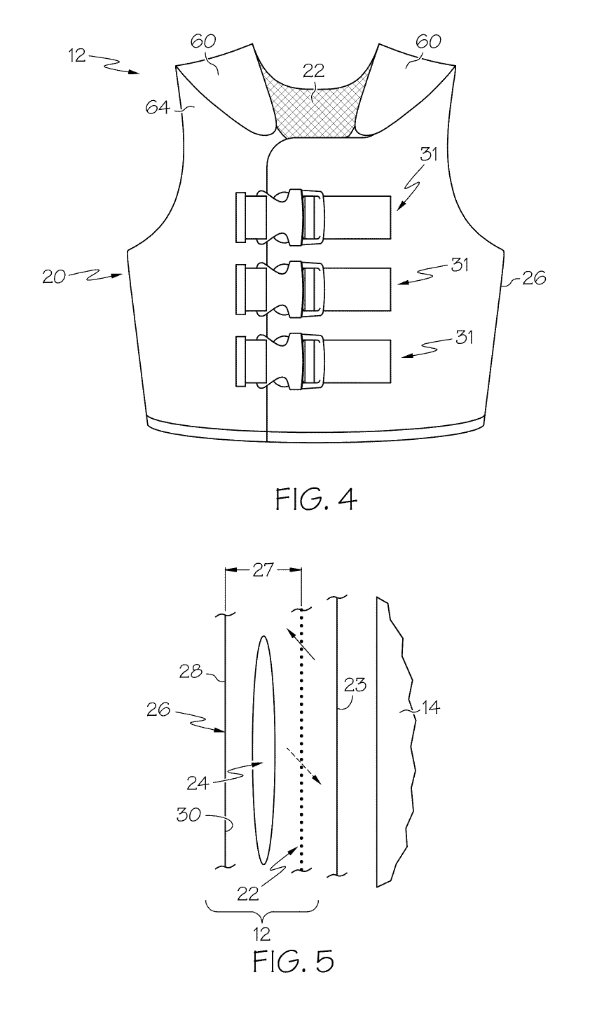

The outer vest portion 20 further includes buckles 31 coupled to the outer surface 28 of the shell 26. Illustratively, the vest 12 shown in FIG. 4 includes three buckles 31, while the vest 12 shown in FIGS. 2 and 3 includes four buckles 31. Accordingly, it is it is within the scope of this disclosure to provide a vest having any suitable number of buckles 31 to secure the vest 12 about the patient 14. Further, it is within the scope of this disclosure for the outer shell 26 to include other fasters, such as snaps, ties, buttons or hook-and-loop fasteners to secure the vest 26 about the patient 14.

Illustratively, each buckle 31 includes a first strap 32 having a first strap member 34 coupled at one end to the outer surface 28 of the shell 26, and a male fastener 36 coupled to the other end of the strap member 34. Each buckle 31 also includes a second strap 42 including a second strap member 44 coupled at one end to the outer surface 28 of the shell 26, and a female fastener 46 coupled to the other end of the second strap member 44. In use, the male fastener 36 is received within the corresponding female fastener 46 in order to couple the first and second straps 32, 42 together to secure the vest 12 about the patient 14. Further illustratively, the length of the first and/or second strap members 34, 44 (i.e., the length between the end of the strap member 34, 44 coupled to the outer surface 28 of the shell 26 and the respective fastener 36, 46) may be adjusted in order to tighten or loosen the vest 12 on the patient 14.

As shown in FIG. 2, the outer shell 26 generally includes three portions: a left chest portion 50, a right chest portion 52, and a center back portion 54 positioned between the left and right portions 50, 52. The left portion 50 of the garment 20 includes the first straps 32 and the right portion 52 includes the second straps 42 of the each buckle 31. The left and right portions 50, 52 each also include an aperture 56 formed through the inner and outer surface 30, 28 of the shell 26. As is discussed in greater detail below, one of the hoses 18 is configured to be received through each of the apertures 56 to connect to the bladder 24 of the vest 12.

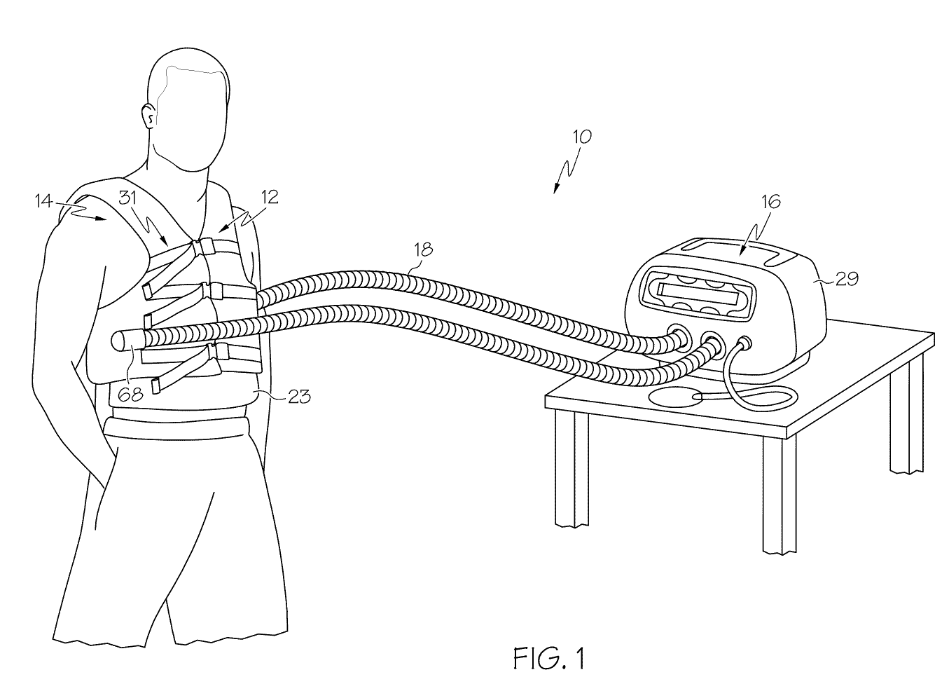

Looking still to FIGS. 2 and 4, the center portion 54 of the outer shell 26 includes left and right shoulder strap flaps 60 coupled to a back region 62 of the center portion 54. The left portion 50 includes a left chest flap 64 and the right portion 52 similarly includes a right chest flap 64. As shown in FIGS. 1 and 4, when the vest 12 is secured to the patient 14, the left shoulder and chest flaps 60, 64 are secured to each other and the right and shoulder and chest flaps 60, 64 are secured to each other in order to further secure the vest 12 around the patient 14. The respective flaps 60, 64 are secured to each other through the use of a hook-and-loop fastener in that the outer surface 28 of the right and left chest flaps 64 of the outer shell 26 includes one of a hook or loop fastening pad (not shown) while the inner surface 30 of the right and left shoulder strap flaps 60 of the outer shell 26 includes the other of the hook and loop fastening pad (not shown). It is within the scope of this disclosure, however, for the flaps 60, 64 to be coupled to each other using other suitable fasteners such as snaps, buttons, ties, etc., for example.

Accordingly, the shoulder strap flaps 60, 64 of the outer shell 26 cooperate to define a pair of upright shoulder straps of the shell 26 which are laterally spaced-apart by a concave, or U-shaped, upper back edge of the shell 26. The front chest flaps 64 of each of the right and left front chest portions 50, 52 are separated from the center strap flaps 60 with concave curved upper edges which allow the vest 12 to fit under the arms of the patient 14. As shown in FIGS. 1 and 4, the shoulder strap flaps 60 extend forwardly over the patient's shoulders and downwardly over chest flaps 64.

As noted above, the outer portion 20 of the vest 12 further includes the inner liner 22 coupled to the outer shell 26 to define the pocket 27 therebetween. The inner liner 22 is coupled to and configured to lie adjacent the inner surface 30 of the outer shell 26 such that the inner liner 22 is also configured to lie adjacent the patient 14, as shown diagrammatically in FIG. 5. More specifically, the inner liner 22 is configured to lie adjacent the T-shirt 23 or other clothing item worn by the patient 12. The inner liner 22 is substantially the same shape and size as the outer shell 26. As such, the inner liner 22 and the outer shell 26 are coupled to each other along the periphery of each of the outer shell 26 and the inner liner 22. Illustratively, the inner liner 22 is stitched to the outer shell 26 at a plurality of locations along the outer edge, or periphery, of the outer shell 26 and the inner liner 22. Specifically, the outer shell 26 and inner liner 22 are stitched to each other at a plurality of locations along the sides and upper edges of the chest and back portions 50, 52, 54 of the outer shell 26 and inner liner. Alternatively, the inner liner 22 may be coupled to the outer shell 26 at the periphery of both items by other suitable attachments such as buttons, ties, glue, etc. at a plurality of individual locations, or along the entire or substantially entire outer edges, of the periphery of the inner liner 22 and the outer shell 26.

Illustratively, the inner liner 22 is also coupled to the outer shell 26 through a zippered connection at the bottom edge of both the inner liner 22 and the outer shell 26. As shown in FIGS. 2 and 3, for example, the outer shell 26 includes a first zipper portion 70. The inner liner 22 includes the corresponding second zipper portion (not shown) along the bottom edge of the inner liner 22 in order to allow a patient or other caregiver access to the pocket 27 between the inner liner 22 and the outer shell 26. Further illustratively, a zippered closure between the outer shell 26 and the inner liner 22 allows for assembly and disassembly of the vest 12 such that the inner bladder 24 may be removed and the outer shell 26 and liner 22 may be laundered. While the outer shell 26 and the inner liner 22 are coupled at bottom edges thereof by the zippered closure, it is within the scope of this disclosure to include other releasable closures or fasteners such as snaps, buttons, ties, hook-and-loop pads, etc., to couple the outer shell 26 and inner liner 22 together provide access to the pocket 27 between the outer shell 26 and the inner liner 22.

Alternatively, the inner liner 22 may include an upper portion and a lower portion releasably coupled to the upper portion via the zippered closure in order to provide access to the pocket 27 between the inner liner 22 and the outer garment 20. In other words, it is within the scope of this disclosure to provide access to the pocket 27 via any suitable releasable fastener coupled to one or more of the inner liner 22 and the outer shell 26.

Looking again to FIGS. 2 and 3, the inner bladder 24 is shaped similar to that of the outer shell 26. As such, the bladder 24 conforms to the shape and contour of the space or pocket 27 between the outer shell 26 and the liner 22. Illustratively, therefore, the inner bladder 24 includes a left chest portion 51 a right chest portion 53 and a center back portion 55 positioned between the left and right chest portions 51, 53. The center back portion 55 includes a pair of upright back sections or flaps 61 configured to align with and fit into pocket areas in the shoulder strap flaps 60 of the outer shell 26 between the outer shell 26 and the liner 22. The bladder flaps 61 are laterally spaced-apart from each other by a concave, or U-shaped, upper back edge of the bladder 24. Similarly, the front left and front right chest portions 51, 53 of the bladder 24 are each separated from the center flaps 61 by a concave curved upper edge which generally aligns with the same outer edges of the outer shell 26, as shown in FIG. 3. As with the outer shell 26 and the liner 22, the bottom section of the bladder 24 is linear and has a length substantially equal to that of the zippered closure 70.

Illustratively, the bladder 24 is made from two air impermeable plastic sheet members. These sheet members may also include an antimicrobial treatment and/or be made from an antimicrobial material. Furthermore, the outer shell 26 and inner liner 22 may also include an antimicrobial treatment and/or be made from an antimicrobial material. The sheet members of the bladder 24 each define outer peripheral edges which are RF welded together to define a single airspace therein. In other words, no portions of the bladder 24 other than the outer peripheral edges of each of the two separate sheets are welded together to create the bladder 24. However, it is within the scope of this disclosure to provide a bladder wherein the front and back panels of the bladder are connected to each other at locations other than the outer peripheral edges to define one or more separate or interconnected airspaces therein. As noted above, the bladder 24 is RF welded along its outer edge or periphery to create and define the internal airspace between the two bladder sheets. It is also within the scope of this disclosure to heat seal, glue, or otherwise couple the two sheet members of the bladder 24 together to create an air impermeable seal or seals along the outer edges of each sheet member.

Illustratively, the bladder sheets 24 are welded to each other intermittently along the outer edges to provide small gaps or spaces between the bladder sheets 24 to allow air to leak therethrough. Such low air loss or leakage through the outer edges of the bladder 24 operates to circulate air around the patient to help cool the patient and remove moisture vapor between the patient 14 and the vest 12. Alternatively, or in addition to the openings at the outer edges of the bladder 24, the bladder 24 may be provided with small perforations (not shown) formed in the inner sheet of the bladder 24 which faces the patient 14 when the vest 12 is worn by the patient 14. Such perforations may also help to circulate air and remove moisture vapor between the patient 14 and the vest 12 to improve the comfort and fit of the vest 12 on the patient 14 during use. While the bladder 24 of the present disclosure is configured to include peripheral openings and/or perforation formed in one or more of the sheets of the bladder 24, it is within the scope of this disclosure to provide a vest having a generally airtight bladder which does not provide any intentional low air loss leaks therefrom.

The bladder 24 further includes first and second elbow connectors or air duct pipes 68 coupled to the outer sheet of the bladder 24. Illustratively, the connectors 68 are positioned near the bottom edge of the bladder 24. In particular, a first connector 68 is coupled to the first chest portion 51 of the bladder 24 while the second connector 68 is coupled to the second chest portion 53 of the bladder 24. The connectors 68 are aligned with the apertures 54 of the outer shell 26 and are configured to be received through the respective apertures 54 of the outer shell 26 to connect with one of the two hoses 18 of the system 10. As shown in FIG. 1, the connectors 68 are generally located at or near the patient's right and left side when the vest 12 is being worn by the patient 14. However, the connectors 68 may be positioned at any suitable location on the bladder 24. Further illustratively, the connectors 68 are rotatable 360-degrees with respect to the bladder 24 to accommodate for multiple positioning of the hoses 18 and/or the air pulse generator 16 relative to the patient 14 and the vest 12 during treatment.

Looking still to FIGS. 2 and 3, the inside surface 28 of the outer shell 26 and the outside sheet of the bladder 24 each include a plurality of corresponding male and female snap fastener connectors 74, 76. As such, the snap fastener connectors 74, 76 allow the bladder 24 to be removably coupled to the outer shell 26. Thus, the bladder 24 may be un-coupled from the outer shell 26 and removed from within the pocket 27 of the outer garment 20 via the zippered closure between the outer shell 26 and the inner liner 22. While the illustrative snap fastener connectors are shown, it is within the scope of this disclosure to provide other releasable connectors in order to couple the bladder 22 to the outer shell 26, such as hook-and-loop fasteners, buttons, ties, etc.

As noted above, the vest 12 includes the inner liner 22 coupled to the outer shell 26 to create a pocket 27 configured to removably receive the air bladder 24 therein. As noted above, the inner liner 22 is illustratively made from a breathable, three-dimensional (3D) material which operates to cool the patient 14 wearing the vest 12 during operation of the HFCWO system 10 and which also operates to remove moisture vapor from the area between the bladder 24 and the patient 14. In other words, the 3D inner liner 22 operates to facilitate a micro-climate that helps to pull away moisture and heat build up during a HFCWO treatment.

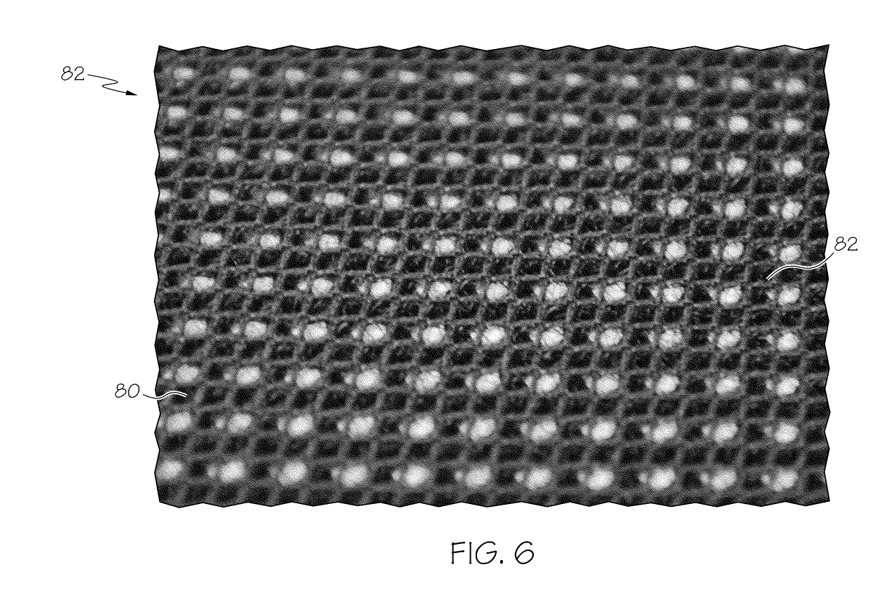

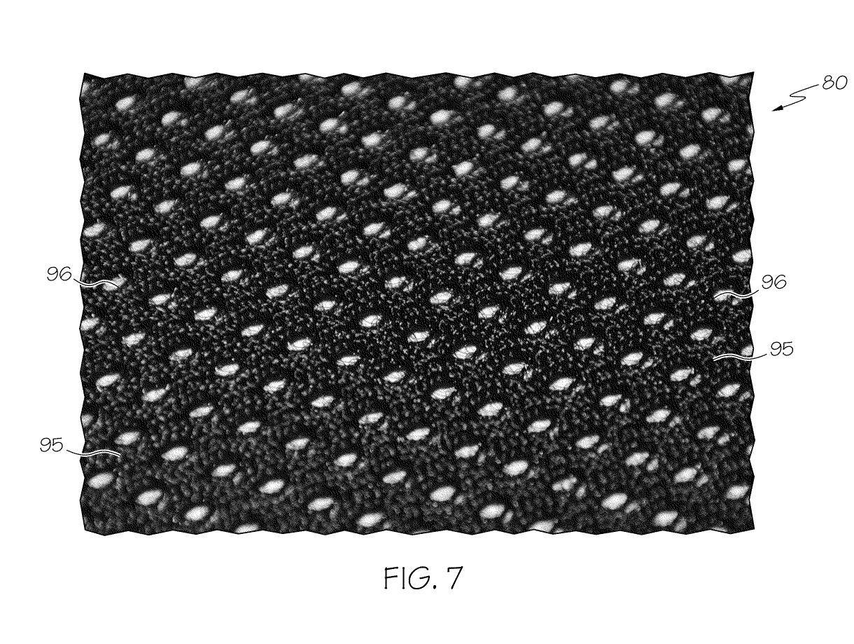

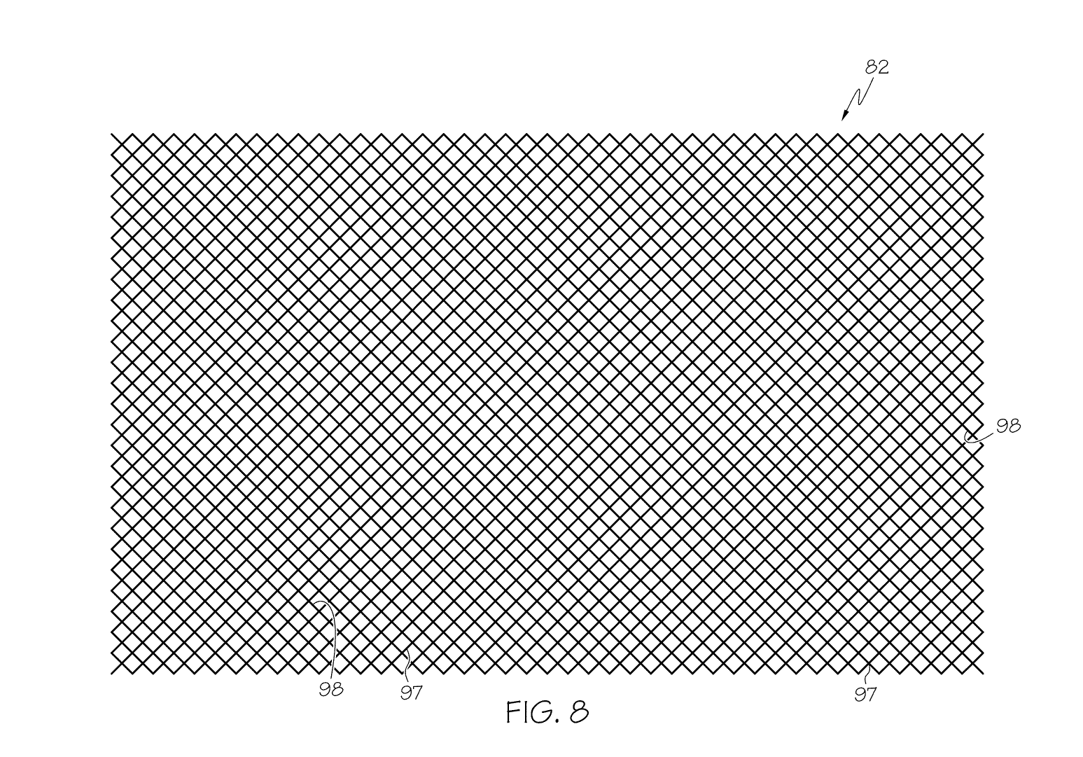

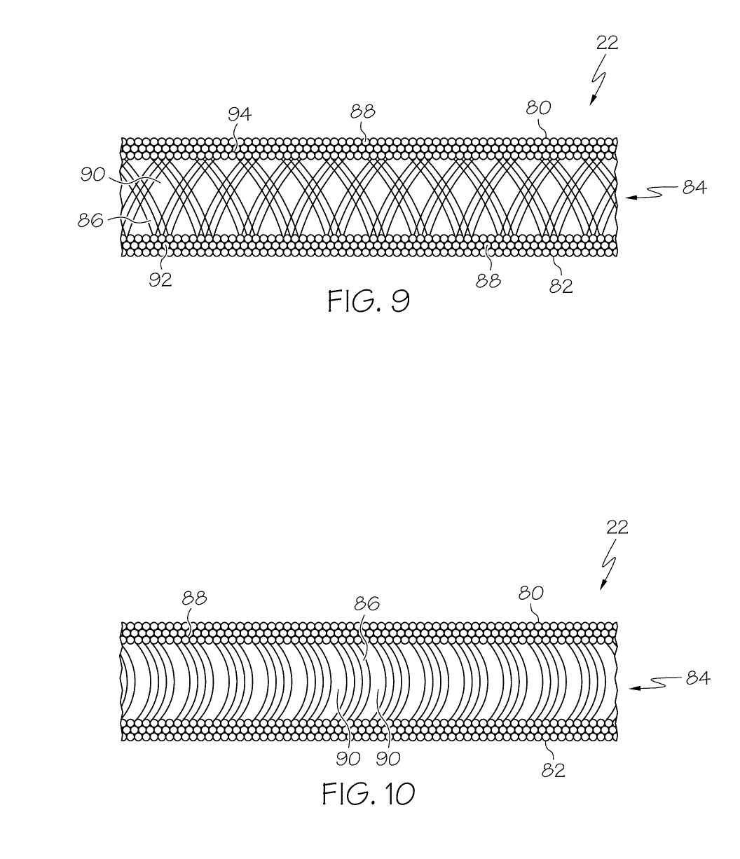

Looking now to FIGS. 6-9 and FIGS. 9 and 10, which illustrate simplified cross sections of an exemplary 3D inner liner 22, the inner liner 22 includes a first mesh outer layer 80 (shown in FIG. 7) and a second mesh inner layer 82 (shown in FIG. 8). The liner 22 further includes a middle region 84 (shown in FIGS. 9 and 10) including a plurality of support fibers 86 and air spaces 90. Outer and inner layers 80, 82 of the inner liner 22 include a cloth or fabric having knit or woven fibers, threads, or strands 88. Illustratively, the support fibers 86 are microfibers woven back and forth between the two woven, mesh layers 80, 82. Each support fiber 86 has at least a first portion 92 coupled to a bottom layer 82 and a second portion 94 coupled to an outer layer 80. As shown, the support fibers 86 are substantially vertically oriented between the outer and inner layers 80, 82. Different illustrative vertical arrangements of the fibers 86 are shown in FIGS. 9 and 10. Spaces 90 are provided between the fibers 86 to allow air to circulate through the 3D liner 22. The density of the fibers within the middle portion 84 helps determine the level of airflow through the material, as well as the support strength of the material. In general, as the density of the fibers 86 increases, the air flow decreases and the support strength increases. The configuration of middle region 84 and outer and inner layers 80, 82 of the inner liner 22 of the present disclosure results in a springy, stretchy, resilient material that his capable of providing cushioning as well as support and is stretchable in longitudinal and lateral directions.

As shown in FIGS. 7 and 8, the outer and inner mesh layers 80, 82 of the inner liner 22 are different from one another. Illustratively, the outer mesh layer 80 includes a mesh material 95 having generally circular apertures 96 formed therethrough. Similarly, the inner mesh layer 82 includes a mesh material 97 having generally diamond-shaped apertures 98 formed therethrough. Illustratively, the mesh material 95 of the first mesh layer 80 is more tightly woven and includes a greater quantity of woven material 95 between the apertures 96 than the amount mesh material 97 between the apertures 98 of the second mesh layer 82. The inner mesh layer 82, on the other hand, includes a looser, more open, weave fibers. Thus, the air permeability between the two layers 80, 82 is different. Further illustratively, the circular apertures 96 are generally larger than the diamond-shaped apertures 98. In other words, a diameter of the circular apertures 96 is generally greater than the height or width of the diamond-shaped apertures 98. However, it is within the scope of this disclosure to include mesh layers having apertures of generally the same size, as well as having apertures wherein the apertures on the inner mesh layer 82 are larger than the apertures of the outer mesh layer 80. It is further within the scope of this disclosure to include mesh layers having apertures of different shapes and sizes than those shown in FIGS. 7 and 8. Further illustratively, the top and bottom mesh layers 80, 82 are assembled with the middle region 84 such that the apertures 96, 98 are offset from each other. In other words, the center of the apertures 96 is not aligned with the center of the apertures 98. However, it is within the scope of this disclosure to align the apertures 96, 98 of the mesh layers 80, 82 as well.

As discussed above, the 3D inner liner 22 includes a fiber network formed of the woven, first mesh layer 80, the woven, second mesh layer 82, and the middle layer or region 84 including the spaces 90 and the fibers 86 woven back and forth between each of the first and second mesh layers 80, 82 to give the material its third dimension. The mesh layers 80, 82 and the fibers 86 within the middle region 84 of the inner liner are made from polyester. However, it is within the scope of this disclosure to include an inner liner made from other suitable natural and/or synthetic materials as well. The illustrative inner liner 22 shown in FIGS. 6-10 is made from “3D Spacer Mesh” knitted fabric material manufactured by Li-Cheng Enterprise Col, Ltd (Taiwan). The manufacturer part number is R24301T.

While the specific inner liner 22 is shown in FIGS. 6-10 and described above, it is within the scope of this disclosure to include an inner liner made from any woven, knitted, or non-woven spacer fabric which is soft and flexible and/or which comprises thermoplastic fibers or monofilaments. In particular, another example of such a 3D material is manufactured by SpaceNet, Inc. of Monroe, N.C. The SPACENET® fiber networks are typically made by thermo-mechanical deformation of textile fabrics that are in turn made from thermoplastic fibers that have projections and optional depressions. Other 3D materials having a plurality of resilient or compressible projection and depressions include Model No. 5875, 5886, 5898, and 5882 materials from Muller Textile as well as a molded thermoplastic spacer matrix material available from Akzo Nobel. Further illustratively, the 3D liner may be made from a three-dimensional fiber network or knit material, such as Tytex manufactured by Tytex Group (Tytex Inc. of Rhode Island, U.S.A). It is also within the scope of this disclosure for the inner liner to include a three-dimensional knit material such as Tytex, in addition to the SpaceNet or other 3D material. The 3D material may also include multiple layers such as is described in U.S. patent application Ser. No. 11/119,980, which is incorporated herein by reference.

Reference also is made to U.S. Pat. Nos. 5,731,062 and 5,454,142 disclosing three dimensional fiber networks made from textile fabrics that have projections and optional depressions which are compressible and return to their original shape after being depressed. U.S. Pat. Nos. 5,731,062 and 5,454,142 are owned by Hoechst Celanese Corporation, Somerville, N.J. Such material is a synthetic thermoplastic fiber network in flexible sheets having projection and/or indentations for use as cushions and/or impact-absorbing components. The descriptions of such patents are incorporated herein by reference to establish the nature of an alternative example of a 3D material.

It should be further understood that the inner liner 22 may be made from any type of 3D material having a spring rate in both the X and Y axes such that the inner liner is stretchable in at least two directions. Preferably such material is open and breathable to provide air passage through the material. Further preferably, the material used to make the inner liner includes three dimensional fiber layer networks made from textile fibers wherein the liner is compressible and able to return to its original shape after being compressed. Therefore, the term “three dimensional material” is meant to include any of these types of materials used in accordance with the present invention.

In use, the vest 12 is secured around the patient 14, as illustrated in FIG. 1. The buckles 31 are secured to each other and tightened around the patient 14 and the shoulder straps flaps 60 are secured to the chest flaps 64 to further secure the vest 14 around the patient 14. The hoses 18 are connected to the elbow connectors 68 of the vest 14 and to the air pulsator 16 in order to deliver the pulsed air to the bladder 24 of the vest to open airways, mobilize secretions, and clear mucus from the lungs of the patient 14. As noted above, the inner liner 22 is positioned adjacent the patient 14, and more specifically, is positioned adjacent the T-shirt 23 worn by the patient 14. The inner liner 22 operates to circulate and cool the air between the vest 12 and the patient 14. During operation of the vest, the air pulse generator 16 warms up and supplies warm air to the bladder 24. Further, the patient's skin also warms up from the micro capillary stimulization during the HFCWO treatment itself. Thus, the warm air in the bladder 24 as well as the muscle exertion of the patient 14 during treatment cooperate to raise the temperature of the interface between the patient 14 and the vest 12. The 3D material of the inner liner 22 allows this heat and moisture vapor that builds up during treatment to escape and also allows cooler room air to take its place between the compressions of the vest 12. Illustratively, when the inner bladder 24 of the vest 12 is inflated but not pulsed, the inner liner 22 remains in an un-collapsed or un-crushed state, such as that shown in FIGS. 9 and 10, whereby the outer and inner mesh layers 80, 82 are spaced-apart from each other by the middle area 84. As the bladder 24 pulses, however, during the HFCWO treatment, the inner liner 22 is crushed, or collapsed, such that the top and bottom mesh layers 80, 82 are adjacent each other. The fibers 86 in the middle area 84 then operate to expand the inner liner 22 such that the outer and inner mesh layers 80, 82 spring-back to the un-collapsed state. This movement of the liner 22 between the un-collapsed and collapsed (i.e., expanded) positions operates in synchronization with the pulsation of the bladder 24 to circulate and cool the surrounding air. In particular, as the inner liner 22 is moved to the collapsed state, warmer air within the spaces 90 of the middle region 84 of the liner 22 is forced out. As the inner liner 22 then springs-back to the un-collapsed state, cooler air is drawn back in through the larger apertures 98 on the inner mesh layer 82 facing toward the patient 14. Thus, the 3D material is compressed and released repeatedly at approximately the same rate at which the bladder is pulsed (i.e., between 5 Hz-20 Hz). This continuous collapsing and expanding of the inner liner 22 thus operates to pull air in and out away from the patient 14 to circulate and cool the air around the patient.

The present disclosure also contemplates preferred characteristics of the three dimensional engineered material which operate to optimize the heat and moisture vapor distribution, but which also operate to prevent or minimize any attenuation of the pressure pulses felt by the patient wearing the vest. In particular, if the inner liner is too thick or too dense, the bladder 24 may not be able to sufficiently expand against the patient 14 to effectively provide the HFCWO treatment to the patient 14. If the inner liner is too stiff, the inner liner may effectively operate like a spring and dampen the pulsing force. However, if the inner liner is too soft, it may remain in a collapsed or crushed state throughout the HFCWO treatment and thus not provide sufficient air circulation and cooling of the area between the patient 14 and the vest 12.

While the inner liner 22 operates to circulate and cool the air around the patient 14, the inner liner 22 also helps to prevent the vest 12 from “creeping” upwardly on the patient 14. Oftentimes, during HFCWO treatment, a vest worn by a patient may tend to move upwardly relative to the patient. However, the diamond-shaped apertures 98 of the top mesh layer 82 operate to grab or cling to the cotton T-shirt 23 or other such shirt worn by the patient 14. Therefore, when the patient's T-shirt is tucked in, the mesh layer 82 clings to the T-shirt to prevent movement of the vest 12 relative to the patient's T-shirt 23, thus preventing the vest 12 from creeping upwardly on the patient 14.

Illustratively, while the particular vest 12 is shown and described herein, it is within the scope of this disclosure for inner liner 22 to be used with other vests as well. For example, U.S. Application Publication No. 2008/0000477, the disclosure of which is hereby expressly incorporated herein, discloses a number of illustrative vests which may be used with a liner, such as the inner liner 22, in order to circulate and cool the air around the patient 14 as well as reduce creep of the vest on the patient 14. Further, the inner liner 22 may be used on other similar devices such as chest wraps (which do not include the shoulder straps of many vest-like devices) as well as on chest vest devices which include a bladder that is only located on the front part of the vest. Such chest vest devices are typically used for patients who are to receive the HFCWO therapy treatment while lying down. Further illustratively, the two-piece design of the vest 12 disclosed herein which allows the user to remove the bladder 24 from within the pocket 27 of the outer garment 20 may similarly be applied to such wrap and chest vest devices as well.

Although certain illustrative embodiments have been described in detail above, variations and modifications exist within the scope and spirit of this disclosure as described and as defined in the following claims.

1. A garment for applying HFCWO treatment to a patient comprising:
an outer shell;
and an inner liner coupled to the outer shell to define a pocket between the outer shell and the inner liner; and
an air bladder removably received within the pocket;
wherein the inner liner is made from a 3D material.

2. The garment of claim 1, wherein the 3D material includes an outer layer, an inner layer, and a third layer woven between the outer and inner layers.

3. The garment of claim 2, wherein the outer and inner layers are made from a woven fabric.

4. The garment of claim 2, wherein the outer layer includes first apertures formed therethrough and the inner layer includes second apertures formed therethrough, wherein the first apertures are larger than the second apertures.

5. The garment of claim 4, wherein the inner layer including the second apertures is configured to lie adjacent a patient during HFCWO treatment and the outer layer including the second aperture is adjacent an inner surface of the outer shell.

6. The garment of claim 1, wherein an outer edge of the inner liner and the outer edge of the outer shell are aligned with and coupled to each other.

7. The garment of claim 6, further comprising a zippered connection between a bottom edge of each of the outer shell and the inner liner.

8. The garment of claim 1, wherein the inner liner is configured to be compressed and expanded during HFCWO treatment as the bladder is pulsed.

9. The garment of claim 1, wherein the bladder includes two plastic sheet members welded to each other only at the outer edge of the sheet members such that the bladder is void of any welds which extend away from the outer edge of the sheet members toward a center of the sheet members.

10. The garment of claim 9, wherein one of the plastic sheet members is perforated to allow air to pass therethrough.

11. The garment of claim 10, wherein the plastic sheet member adjacent the inner liner is perforated.

12. The garment of claim 1, wherein the bladder includes first snap fastener connectors and the outer shell includes second snap fastener connectors configured to mate with the first snap fastener connectors in order to removably couple the bladder to the outer shell.

13. The garment of claim 9, wherein the outer edges of the plastic sheet members are welded intermittently to provide leak areas to allow air to pass therethrough.

14. The garment of claim 1, wherein a portion of at least one of the bladder, the inner liner, and the outer shell is antimicrobial.

15. The garment of claim 1, wherein the inner liner includes an inner mesh layer and an outer mesh layer.

16. The garment of claim 15, wherein the inner liner further includes a middle region between the inner and outer mesh layers.

17. The garment of claim 16, wherein the middle region includes a plurality of fibers coupled to and woven between each of the inner and outer mesh layers, and air spaces between the fibers.

18. The garment of claim 17, wherein the fibers are substantially vertically oriented between the inner and outer mesh layers.

19. The garment of claim 15, wherein the inner mesh layer includes first apertures and the outer mesh layer includes second apertures larger than the first apertures.

20. The garment of claim 19, wherein the inner mesh layer is configured to lie adjacent the patient and the outer mesh layer is configured to engage the bladder.

21. The garment of claim 19, wherein the first apertures are diamond-shaped and the second apertures are circular in shape.

22. A method of providing HFCWO treatment including:
securing a garment around the chest of a patient, wherein the garment includes an outer shell, an inner liner coupled to the outer shell, and a bladder removably received within a space between the outer shell and the inner liner;
coupling the bladder to an air pulse generator;
pulsing the bladder between 5-20 Hz; and
circulating air between the bladder and the patient to cool the patient and remove moisture vapor.

23. The method of claim 22, wherein the inner liner includes inner and outer layers and support fibers woven between the inner and outer layers, and wherein circulating air between the bladder and the patient includes collapsing and expanding the inner and outer layers at approximately the same rate at which the bladder is pulsed.
